(19) United States
(12) Patent Application Publication
(10) Pub. No.: US 2006/0136714 A1
(43) Pub. Date: Jun. 22, 2006

(54) Method and apparatus for encryption and decryption, and computer product

(75) Inventors: Katsuya Yagi, Tokyo (JP); Manabu Ozawa, Tokyo (JP); Kyoko Fujisawa, Ichikawa-shi (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/281,875

(22) Filed: Nov. 18, 2005

Related U.S. Application Data
(63) Continuation of application No. PCT/JP03/06228, filed on May 19, 2003.

(51) Int. Cl. H04L 9/00

(52) U.S. Cl. 713/150; 713/155

(57) ABSTRACT

Each of a client and a server has a pattern table. The client reads a public key from the pattern table to encrypt data. The client adds a pattern number corresponding to the public key used for encryption to the encrypted data, and transmits the encrypted data to the server. The server searches the pattern table based on the pattern number, to specify a combination of the public key and a secret key. The server decrypts the encrypted data based on the secret key to obtain original data.

### BACKGROUND OF THE INVENTION

1. Field of the Invention

The present invention relates to at technology for encryption and decryption of data in data communications.

2. Description of the Related Art

Recently, with the development of network technology such as the Internet, various kinds of important information are transferred via a network. When information is transferred via such an open network, a security measure for preventing falsification and tapping of transferred data, and spoofing is essential.

To achieve secure communications, a communication technology using cryptogram has been proposed. For example, secure sockets layer (SSL) is a communication protocol for encrypting data communicated between a client and a server at a socket level, in which falsification and tapping of data and spoofing are prevented by combining a public key cryptosystem, a common key cryptosystem, and a digital certificate (http://www.verisign.co.jp/repository/faq/SSL/).

When the server authenticates a client by using the SSL, the public key cryptosystem is used to share the common key, and communication is performed by the common key cryptosystem using the common key.

With such authentication method, however, communication (communication by the public key cryptosystem) for sharing the common key is necessary before intended data communication (communication by the common key cryptosystem). Therefore, time, a processing load, and a communication load required for the authentication increases. In addition, if the number of communications increases, the chance of the data being in danger of falsification, tapping, and spoofing also increases.

### SUMMARY OF THE INVENTION

It is an object of the present invention to at least solve the problems in the conventional technology.

An encryption apparatus according to one aspect of the present invention performs encryption on data to be transmitted. The encryption apparatus includes a storage unit configured to store at least one encryption scheme; an encrypting unit configured to encrypt the data based on the encryption scheme; and a transmitting unit configured to transmit encrypted data.

An encryption method according to still another aspect of the present invention is for encrypting data to be transmitted. The encryption method includes storing at least one encryption scheme; encrypting the data based on the encryption scheme; and transmitting encrypted data.

A computer-readable recording medium according to still another aspect of the present invention stores therein a computer program for realizing the encryption method according to the above aspect.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic for illustrating a concept of cryptocommunication according to an embodiment of the present invention;

FIG. 2 is a schematic of a cryptocommunication system according to a first embodiment of the present invention;

FIG. 3 is a schematic of a pattern table;

FIG. 4 is a flowchart of a processing operation by a client;

FIG. 5 is a flowchart of a processing operation by a server;

FIG. 6 is a schematics of pattern tables when a character string is encrypted to perform communication;

FIG. 7 is a schematic for illustrating encryption of the character string;

FIG. 8 is a schematic of a cryptocommunication system according to a second embodiment of the present invention;

FIG. 9 is a flowchart of a processing operation by a client;

FIG. 10 is a flowchart of a processing operation by a server;

FIG. 11 is a schematic of a table of correspondence between a client and a pattern;

FIG. 12 is a schematic of a table of correspondence of a client authentication key, a pattern number, a public key, and a secret key;

FIG. 13 is a flowchart of a processing in a pattern update method; and

FIG. 14 is a flowchart of a restoration processing of the pattern table in the server.

### DETAILED DESCRIPTION OF THE PREFERRED EMBODIMENTS

Exemplary embodiments according to the present invention will be explained in detail with reference to the accompanying drawings.

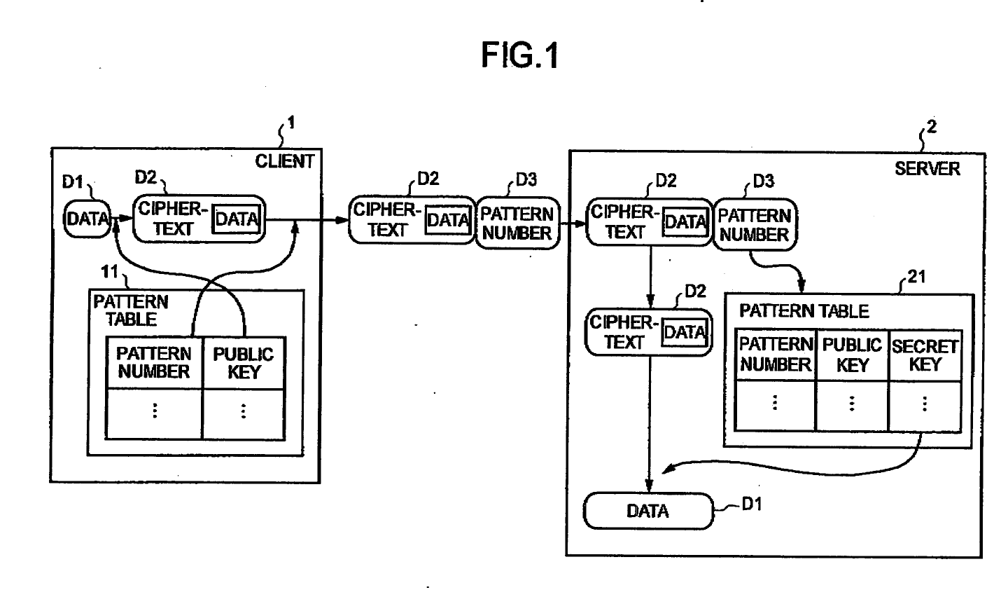

FIG. 1 is a schematic for illustrating a concept of cryptocommunication according to an embodiment of the present invention. As shown in FIG. 1, a client 1 and a server 2 have pattern tables 11 and 21 respectively. The pattern table 21 held by the server 2 stores sets of a public key and a secret key used for Rivest-Shamir-Adleman (RSA) cryptosystem, and allocates a pattern number to the sets of a public key and a secret key. The pattern table 11 held by the client 1 stores the pattern number and the public key.

When transmitting data D1, the client 1 selects a public key to be used from the pattern table 11, and encrypts the data D1 by using the selected public key, to create a ciphertext DZ. The client 1 then adds a pattern number D3 corresponding to the used public key to the ciphertext D2 and transmits these to the server 2.

On the other hand, when having received the ciphertext D2 and the pattern number D3, the server 2 searches the pattern table 21 based oh the received pattern number D3, to specify the public key used for encryption. Thereafter, the server 2 decrypts the ciphertext D2 by a secret key corresponding to the specified public key and extracts the data D1.

The RSA cryptography is based on the fact that prime factorization of a large natural number, which is not a prime number, is difficult. Specifically, optional two large prime numbers p and q are selected, to designate the product thereof as n (n=pq). Euler's function φ(n) derived from the Euler's theorem is defined as φ(n)(p−1)(q−1).

A figure k that is aliqu ant of φ(n) is selected. n and k are used as the public keys. Subsequently, an integer h satisfying 1=hkxmodφ(n) is calculated. The h is used as the secret key. When it is assumed that a plaintext is M and a ciphertext is C, and if M<n, the following relation is established.
C=M^{h}modn
M=C^{h}modn

Based on the relation, as long as the secret key h is not known, even if the public keys k and n are known, huge calculation is required to obtain the secret key from the public keys. Particularly, by increasing the number of digits of the key, calculation of the secret key becomes more difficult.

The generally used RSA cryptography uses this characteristic and maintains communication security by making the public key available to anyone, but keeping the secret key confidential. However, although calculation of the secret key from the public key is difficult, it is not impossible. Therefore, if the public key can be obtained by anyone, it is necessary to use a key of a sufficient number of digits, since the security of communication is determined according to the number of digits of the key.

On the other hand, in the cryptocommunication according to an embodiment of the present invention, the public key is open only to the clients, and is kept secret from other terminals. Furthermore, the pattern number indicates the public key used for encryption by the client. That is, since the public key is not exposed in the data communication, secure cryptocommunication can be realized with a fewer number of digits.

In other words, the terms “public key” and “secret key” are used for convenience' sake of using the RSA encryption method, the public key in the present invention is kept confidential from other terminals, similarly to the common key in the common key cryptosystem.

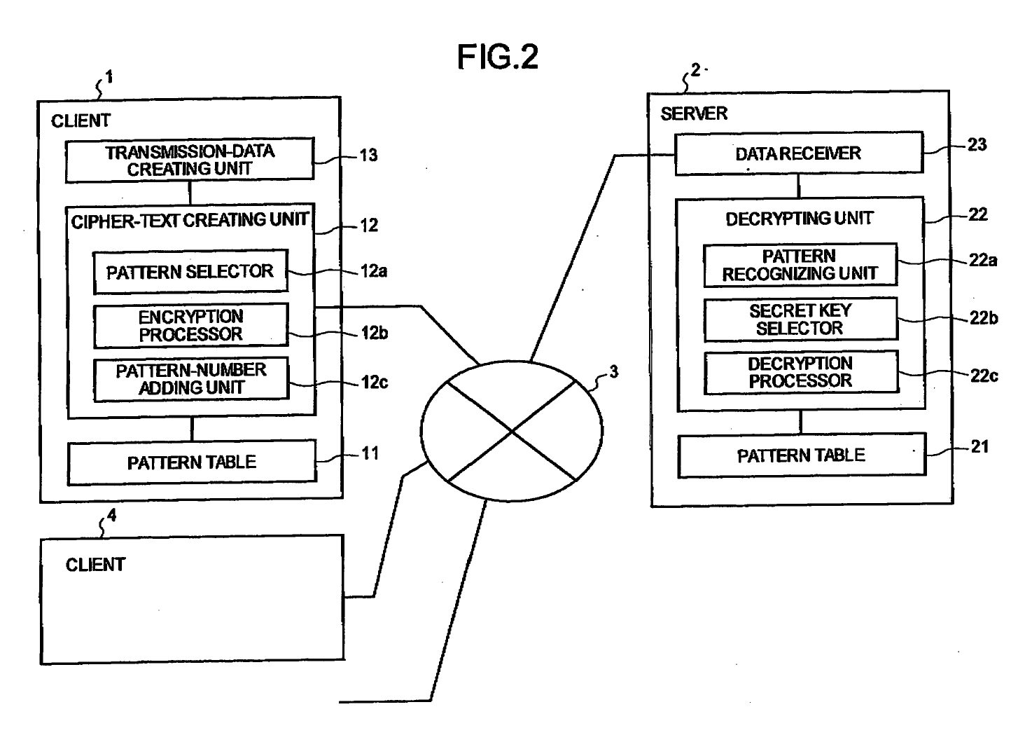

FIG. 2 is a schematic of a cryptocommunication system according to the first embodiment. As shown in FIG. 2, the client 1 is connected to the server 2 via a network 3. A client 4 having the same configuration as that of the client 1 and other clients (not shown) are connected to the server 2 via the network 3.

The client 1 includes a transmission-data creating unit 13, a ciphertext creating unit 12, and the pattern table 11. The transmission-data creating unit 13 creates original data to be transmitted to the server 2, and for example, when authentication is performed between the client 1 and the server 2, creates authentication request data.

The ciphertext creating unit 12 encrypts the data created by the transmission-data creating unit 13, and includes a pattern selector 12a, an encryption processor 12b, and a pattern number adding unit 12c. The pattern selector 12a selects a public key to be used for encryption from the pattern table 11. The encryption processor 12b creates a ciphertext obtained by encrypting the data created by the transmission-data creating unit 13 by using the public key selected by the pattern selector 12a. The pattern number adding unit 12c adds a pattern number corresponding to the used public key.

On the other hand, the server 2 has a data receiver 23, a decrypting unit 22, and the pattern table 21. The data receiver 23 receives the ciphertext from the client, and transmits the received ciphertext to the decrypting unit 22. The decrypting unit 22 decrypts the ciphertext received by the data receiver 23, and includes a pattern recognizing unit 22a, a secret key selector 22b, and a decryption processor 22c. The pattern recognizing unit 22a reads the pattern number added to the ciphertext. The secret key selector 22b specifies the public key used for encryption by using the pattern number read by the pattern recognizing unit 22a, to select a corresponding secret key. The decryption processor 22c decrypts the ciphertext by using the secret key selected by the secret key selector 22b.

The pattern tables 11 and 21 are explained next. In the pattern table, the pattern number is associated with the set of the public key and the secret key. Specifically, a combination of “k” and “n” is stored as the public key, and “h” is stored as the secret key. Alternatively, in the pattern table, a set of parameters used for encryption and decryption, that is, a set of “p”, “q”, and “k” can be stored, instead of the public key and the secret key.

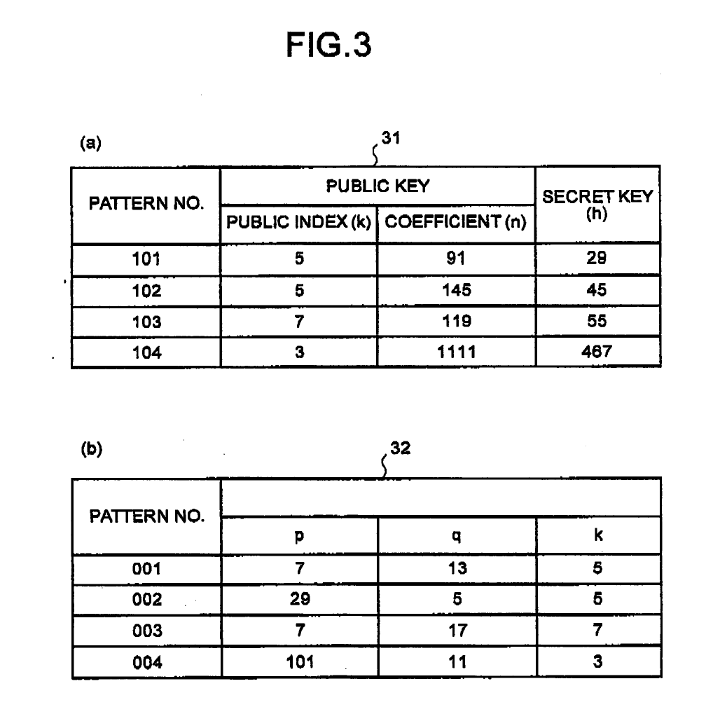

FIG. 3 is a schematic of the pattern table. In a pattern table 31 shown in FIG. 3, a public index “k” and a coefficient “n” are stored as the public key, and “h” is stored as the secret key. For example, in a pattern indicated by a pattern number “101”, the public index is “5”, the coefficient is “91”, and the secret key is “29”. In a pattern indicated by a pattern number “102”, the public index is “5”, the coefficient is “145”, and the secret key is “45”. Likewise, a pattern number “103” shows a combination of the public index “7”, the coefficient “119”, and the secret key “55”, and a pattern number “104” shows a combination of the public index “3”, the coefficient “1111”, and the secret key “467”.

On the other hand, in a pattern table 32 shown in FIG. 3B, a combination of parameters “p”, “q”, and “k” is stored in association with the pattern number. For example, in a pattern indicated by a pattern number “001”, “p=7, q=13, k=5”. In a pattern indicated by a pattern number “002”, “p=29, q=5, k=5”. Likewise, in a pattern indicated by a pattern number “003”, “p=7, q=17, k=7”, and in a pattern indicated by a pattern number “004”, “p=101, q=11, k=3”.

The server 2 stores the combination of the pattern number, the public key, and the secret key, or the combination of the pattern number and the parameters, for all patterns used by respective clients. On the other hand, respective clients store only a part of the pattern table, that is, only the pattern used by the own terminal. Respective clients do not need to store the secret key, and need only to store the combination of the pattern number and the public key as the pattern table.

Thus, since respective clients store only the pattern used by the own terminal, and do not store the secret key, the security of the cryptocommunication can be increased.

A specific example of ciphertext creation is explained with reference to the pattern table shown in FIG. 3. For example, when a pattern 104 shown in the pattern table 31 is used to encrypt a character “a”, the code of “a” is “0x61”, and when this code is converted to a decimal number, it becomes “97”. Data “97” indicating the character “a” is designated as a plaintext M. By using “k=3, n=1111” of the pattern 104,
(97)³mod(1111)=542
is obtained from M^{k}modn=C, and hence, the ciphertext becomes “542”.

When a pattern 002 shown in the pattern table 32 is used to encrypt the character “a”, “97” obtained by converting the code of “a” to a decimal number is designated as the plaintext M, and by using “p=29, q=5, k=5” of the pattern 002,
(97)⁵mod(29×5)=37,
is obtained from M^{k}mod(pq)=C, and hence, the ciphertext becomes “37”.

Thus, after encryption is performed by using a predetermined pattern, the number of the used pattern is added to the data and transmitted. The server side can specify the secret key to be used for decryption based on the pattern number.

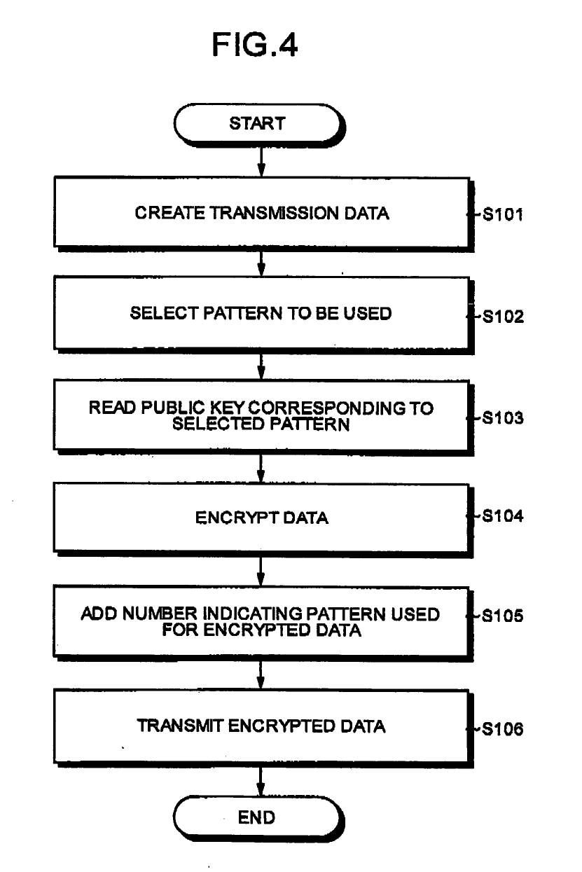

FIG. 4 is a flowchart of a processing operation by the client 1. As shown in FIG. 4, on the client 1 side, when the transmission-data creating unit 13 creates transmission data (step S101), the pattern selector 12a selects a pattern to be used (step S102). The encryption processor 12b then reads the secret key corresponding to the selected pattern (step S103) to encrypt the transmission data (step S104). The pattern number adding unit 12c then adds the pattern number used for the encrypted data thereto (step S105), and transmits the encrypted data (ciphertext) (step S106).

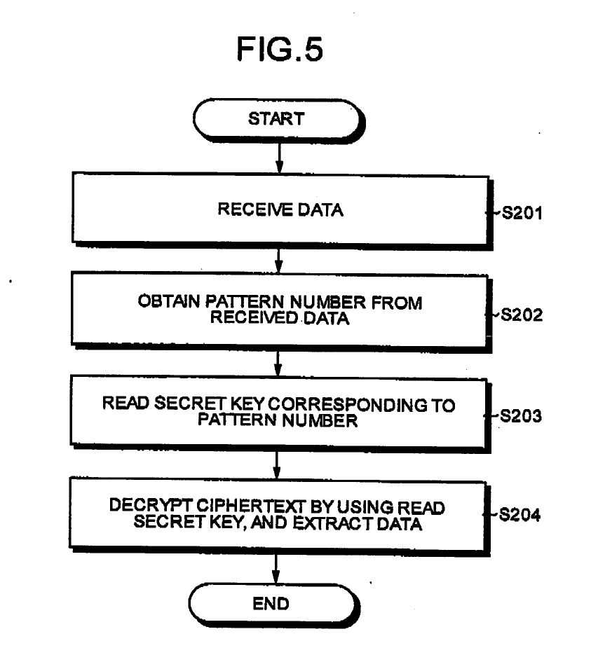

A specific processing operation of the server 2 shown in FIG. 2 is explained next, FIG. 5 is a flowchart of the processing operation by the server 2. As shown in FIG. 5, in the server 2, when the data receiver 23 receives data from the client (step S201), the pattern recognizing unit 22a obtains a pattern number from the data received by the data receiver 23 (step S202). The secret key selector 22b specifies the set of the public key and the secret key used for the encryption based on the pattern number, and reads the corresponding secret key (step S203). Thereafter, the decryption processor 22c uses the read secret key to decrypt the ciphertext, and extracts the original data (step S204), to finish the processing.

In the first embodiment, since a pattern number is set with respect to the set of a public key and a secret key to create a pattern table, the pattern table is shared between the client and the server, and the client adds, to the ciphertext, the pattern number corresponding to the public key used at the time of encrypting the data, and transmits the ciphertext, communication using the public key cryptosystem can be performed without exposing the public key to the communication network.

Since secure cryptocommunication can be realized with a fewer number of digits by keeping the public key confidential, a processing load applied to encryption and decryption can be reduced. Particularly, when the first embodiment is used for authentication between the client and the server, since the client can transmit an authentication request directly, the number of communications can be reduced, and time required for improvement of security and authentication can be reduced.

Although an example of encrypting data of one character and transmitting the encrypted data has been explained above, the present invention is not limited thereto, and is also applicable to an encryption of a character string to be transmitted.

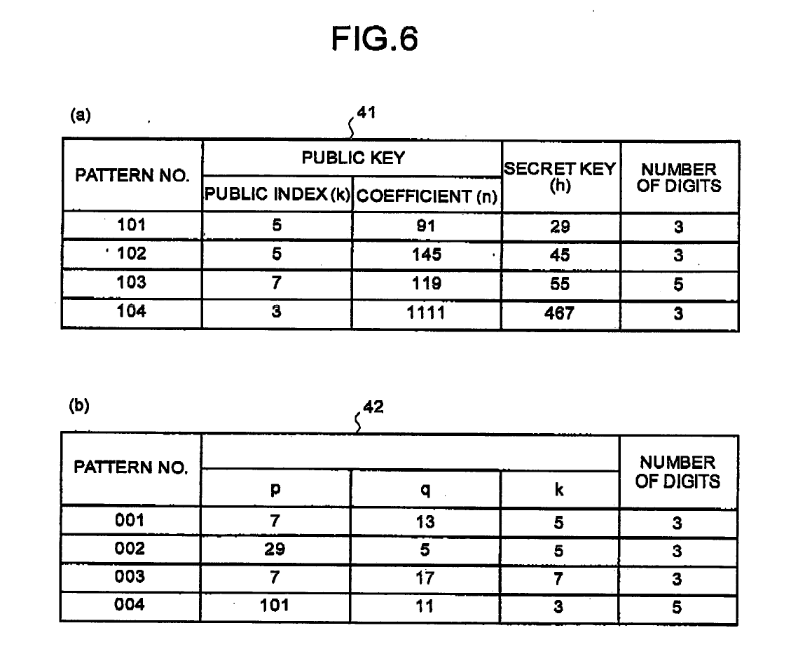

When a character string is encrypted and transmitted, the number of digits for one character can be determined, to divide characters. FIGS. 6A and 6B are pattern tables when a character string is encrypted to perform communication. In a pattern table 41 shown in FIG. 6A, data of the number of digits is added to the pattern table 31 shown in FIGS. 3A and 3B. In a pattern table 42 shown in FIG. 6B, data of the number of digits is added to the pattern table 32 shown in FIGS. 3A and 3B.

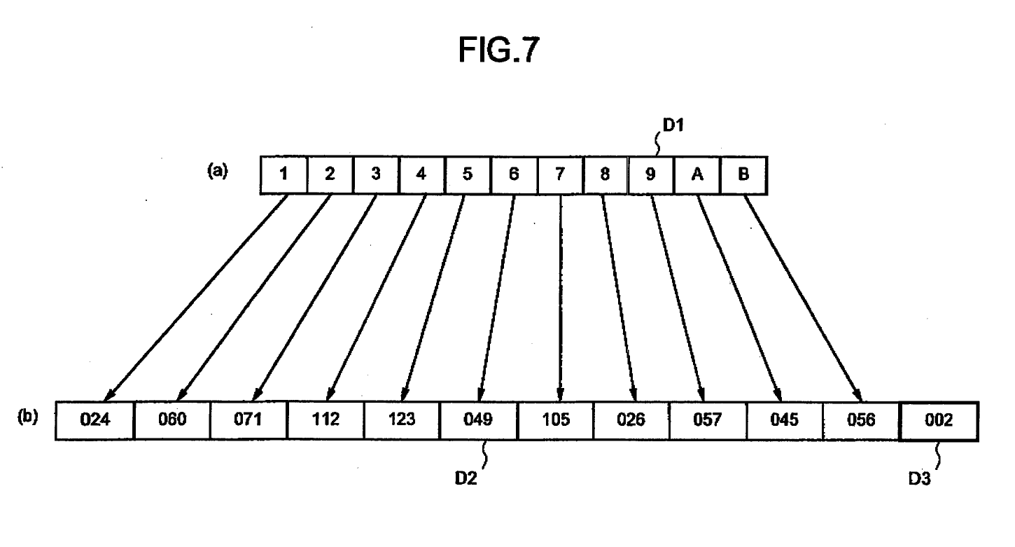

When a character string is encrypted, after respective characters included in the character string are encrypted, the encrypted data is equalized to the number of digits specified in the pattern table. FIGS. 7A and 7B are specific examples of encryption of the character string. Original data D1 shown in FIG. 7A is “123456789AB”. When “1” is encrypted by the pattern 002, it becomes “24”. When the number of digits is matched with 3, it becomes “024”. When “2” is encrypted by the pattern 002, it becomes “60”. When the number of digits is matched with 3, it becomes “060”. Thus, the characters included in the data D1 is sequentially encrypted, and by adjusting respective number of digits to 3, a ciphertext D2 can be created. When the ciphertext is transmitted, the pattern number “002” indicating the used pattern need only be added to the end of the ciphertext D2.

In decryption in the server 2, the pattern number at the end of the ciphertext is identified, to obtain the number of digits provided to the pattern. Accordingly, based on the number of digits, the ciphertext can be divided into characters and decrypted.

Since communication is performed by encrypting the character string in this manner, the number of communications between the client and the server can be further suppressed, the load on the communication line can be also reduced, and the security strength can be increased.

To increase the encryption strength, it is desired to use a different pattern for each communication. To do this, it is only necessary to store a plurality of patterns in the pattern table on the client side, and select a different pattern for each communication. Since the server side can specify the secret key to be used for decryption based on the pattern number added to the ciphertext, even if the client uses a different public key every time the server side can accurately decrypt the ciphertext.

In the first embodiment, the pattern used for encryption is informed to the server by adding the pattern number to the ciphertext. In a second embodiment, a cryptocommunication system in which the server identifies the client to specify a pattern to be used for decryption is explained.

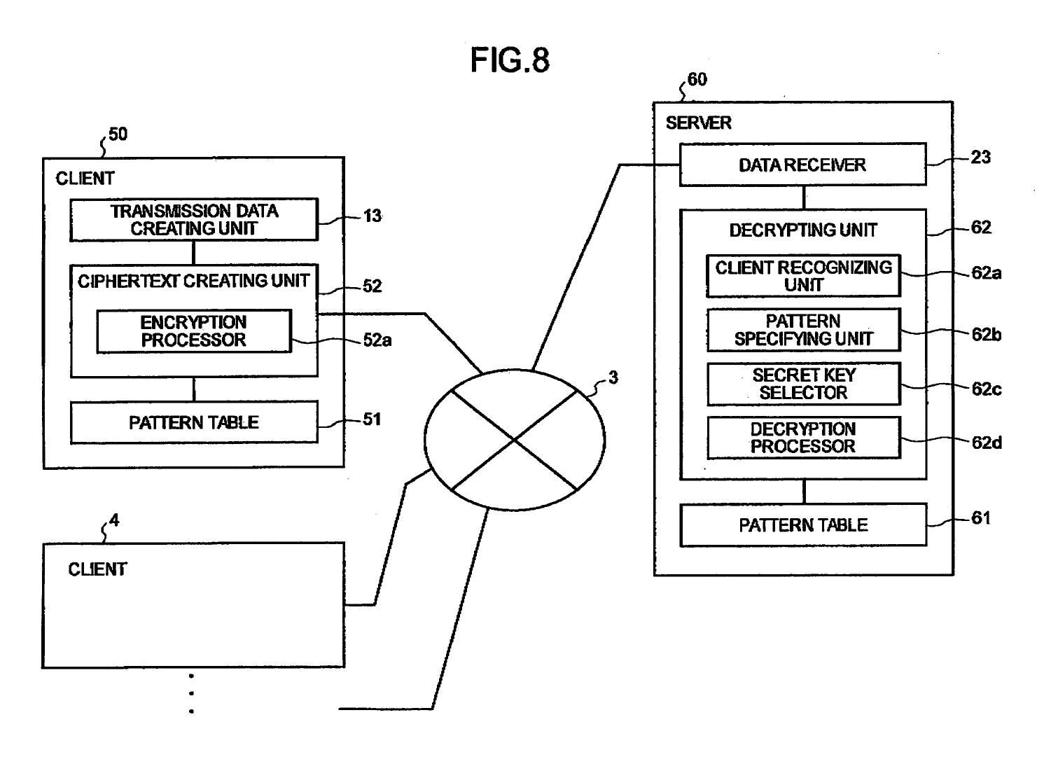

FIG. 8 is a schematic of the cryptocommunication system in the second embodiment. As shown in FIG. 8, a client 50 is connected to a server 60 via the network 3. The client 4 and other clients (not shown) are connected to the server 60 via the network 3, as in the cryptocommunication system shown in the first embodiment.

The client 50 includes the transmission-data creating unit 13, a ciphertext creating unit 52, and a pattern table 51. The transmission-data creating unit 13 creates data to be transmitted to the server. The public key associated with the pattern number is stored in the pattern table 51.

The ciphertext creating unit 52 includes an encryption processor 52a. The ciphertext creating unit 52 creates a ciphertext by using the public key stored in the pattern table 51, and transmits the ciphertext to the server 60. The client 50 does not add the pattern number indicating the public key used for encryption.

On the other hand, the server 60 has the data receiver 23, a decrypting unit 62, and a pattern table 61. The data receiver 23 receives a ciphertext via the network 3, and transmits the received ciphertext to the decrypting unit 62. A pattern number is added to a set of a public key and a secret key to be stored, and information for specifying each client, for example, an Internet protocol (IP) address is associated with a pattern number to be stored in the pattern table 61.

The decrypting unit 62 includes a client recognizing unit 62a, a pattern specifying unit 62b, a secret key selector 62c, and a decryption processor 62d. Upon reception of a ciphertext, the client recognizing unit 62a recognizes the client as a sender by referring to the IP address or the like. The pattern specifying unit 62b specifies a pattern used for encryption based on the recognition result by the client recognizing unit 62a. The secret key selector 62c selects a secret key based on the pattern specified by the pattern specifying unit 62b. The decryption processor 62d decrypts the ciphertext by using the secret key.

In the cryptocommunication system according the second embodiment, the patterns stored on the client side are registered on the server side, and the server identifies the client by using the IP address or a media access control (MAC) address to select a secret key to be used for decryption from the pattern, which can be used by the client.

Therefore, the client need not add the pattern number to the ciphertext, and since only the ciphertext is transmitted via the network, further stronger security can be realized.

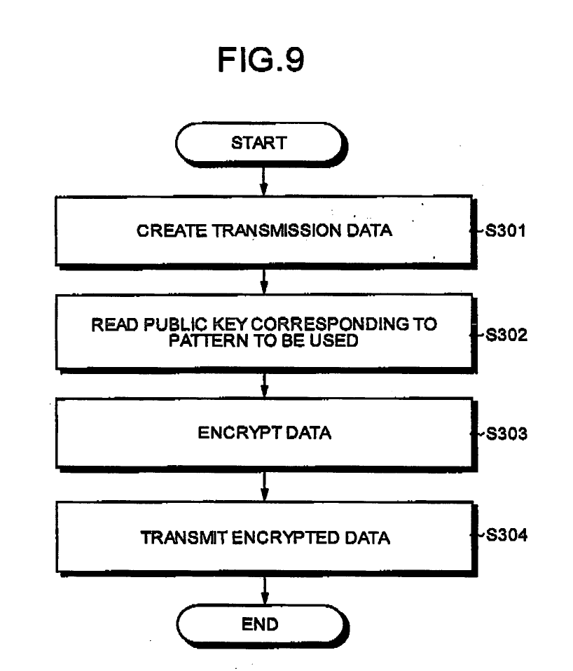

A specific processing operation of the client 50 shown in FIG. 8 is explained next. FIG. 9 is a flowchart of the processing operation by the client 50. As shown in FIG. 8, when the transmission-data creating unit 13 creates transmission data (step S301), the client 50 reads out a public key to be used from the pattern table 51 (step S302). The encryption processor 52a then encrypts the transmission data (step S303) by using the read public key, and transmits the encrypted data (ciphertext) (step S304).

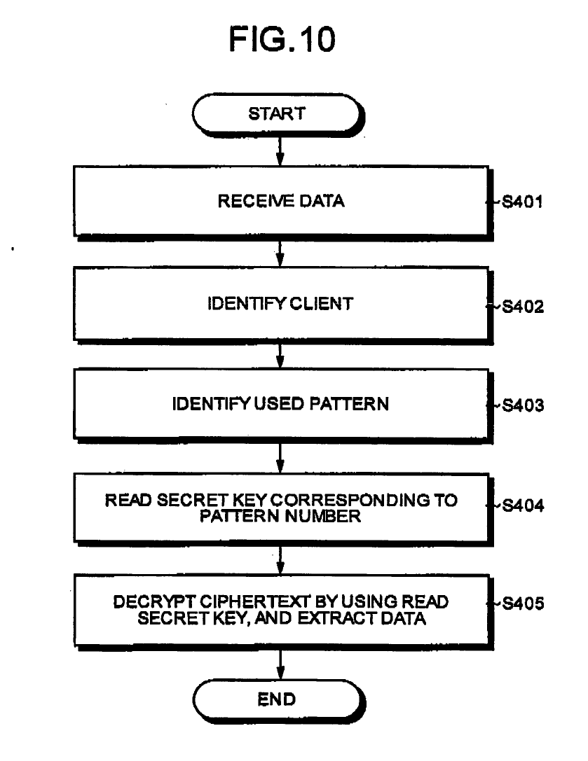

A specific processing operation of the server 60 shown in FIG. 8 is explained next, FIG. 10 is a flowchart of the processing operation by the server 60. As shown in FIG. 10, in the server 60, when the data receiver 23 receives data from the client (step S401), the client recognizing unit 62a identifies the client based on the IP address or the like (step S402). The pattern specifying unit 62b specifies a pattern used by the identified client (step S403). Thereafter, the secret key selector 62c reads out the secret key corresponding to the specified pattern (step S404). The decryption processor 62d then decrypts the ciphertext by using the read secret key, to extract the original data (step S405), and ends the processing.

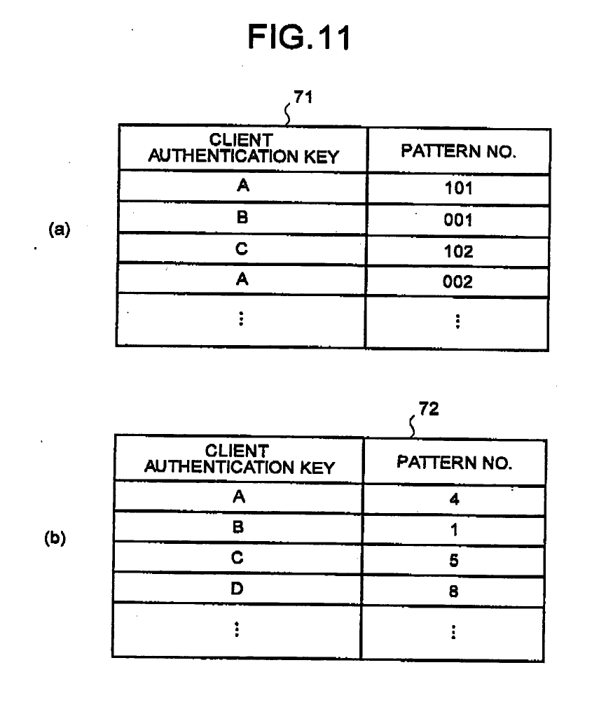

The relation between the client and the pattern, stored in the pattern table 61 of the server 60 is explained. FIGS. 11A and 11B are explanatory diagrams of the correspondence between the client and the pattern. A table 71 shown in FIG. 11A indicates the relation between the client and the pattern. A client authentication key shown in FIG. 11A is optional information that can be used for specifying the client, for example, the IP address or the MAC address. In the table 71, pattern numbers “101” and “002” correspond to a client authentication key “A”. In other words, the ciphertext received from the client specified by the client authentication key “A” has been encrypted by using the pattern “101” or “002”. A pattern number “001” corresponds to a client authentication key “B”, and a pattern number “102” corresponds to a client authentication key “C”. That is, the ciphertext received from the client specified by the client authentication key “B” has been encrypted by using the pattern “001”, and the ciphertext received from the client specified by the client authentication key “C” has been encrypted by using the pattern “102”.

A table 72 shown in FIG. 11B indicates the number of patterns stored by each client. Specifically, the client specified by the client authentication key “A” stores four patterns, and the client specified by the client authentication key “B” stores one pattern. The client specified by the client authentication key “C” stores five patterns, and the client specified by the client authentication key “D” stores eight patterns.

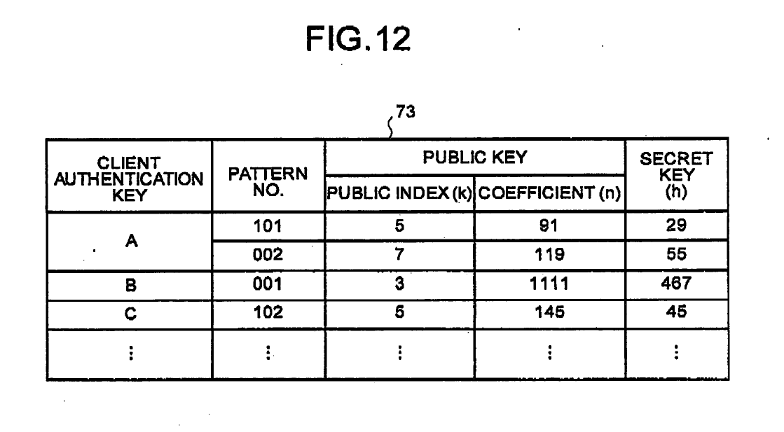

The correspondence between the client and the pattern can be stored together with the correspondence between the public key and the secret key. FIG. 12 depicts a pattern table in which the client authentication key, the pattern number, the public key, and the secret key are associated with each other and stored.

In the second embodiment, a pattern number is set with respect to a set of a public key and a secret key to create a pattern table, and the pattern table is shared by the client and the server. Further, since the pattern stored by the client is registered on the server side, the server can identify the client by using the IP address, the MAC address, or the like, and select a secret key to be used for decryption from the pattern that can be used by the client to perform decryption.

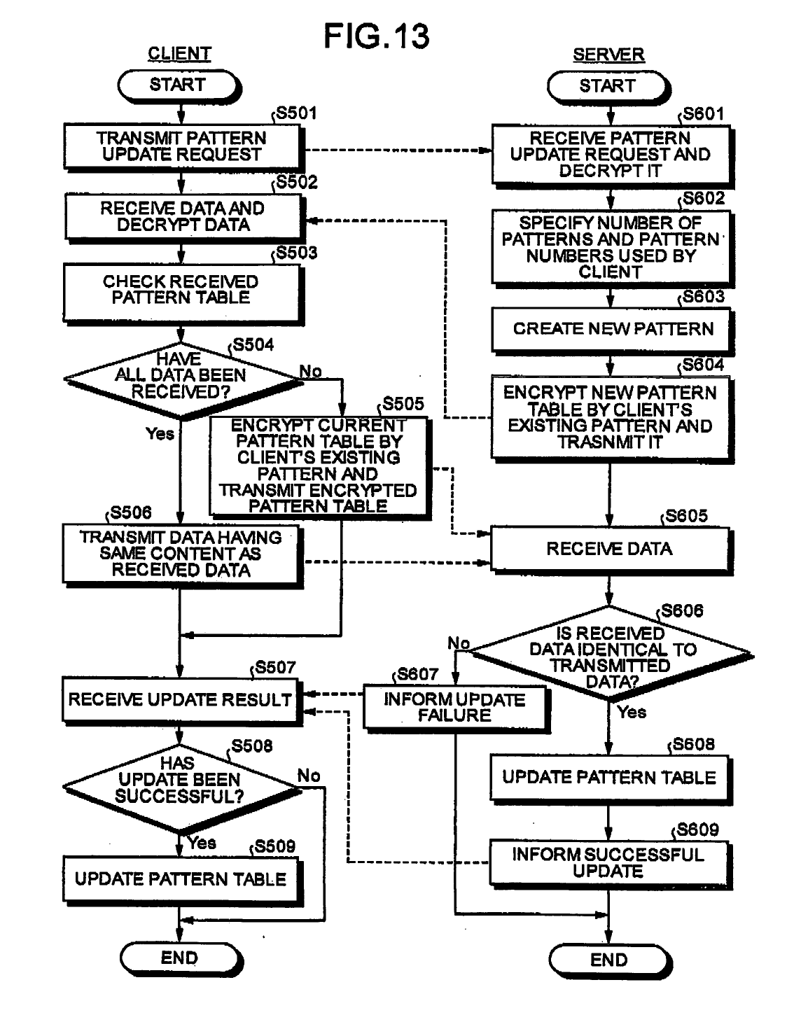

To improve the communication security, it is desired that the pattern used by the client can be updated appropriately. One example of an update method of the pattern in the present invention is explained with reference to FIG. 13. As shown in FIG. 13, when the client encrypts and transmits a pattern update request (step S501), the server receives and decrypts the pattern update request to extract the pattern update request (step S601). The server refers to the pattern table 61 to specify the number of patterns and the pattern numbers used by the client (step S602). The server then creates a new pattern (step S603), encrypts the new pattern table by an existing pattern of the client, and transmits the encrypted new pattern (step S604).

The client receives this data, and decrypts the data to extract the new pattern table (step S502). Thereafter, the client determines whether all necessary data have been received (step S504). If all data have been received (“YES” at step S504), the client transmits data having the same content as the received data to the server (step S506). On the other hand, if all data have not been received (“NO” at step S504), the client encrypts the current pattern table by the existing pattern of the own terminal and transmits the encrypted pattern table to the server (step S505).

The server receives the data transmitted by the client (step S605). If the received data is identical to the transmitted data (“YES” at step S606), the server updates the pattern table (step S608), and informs the client of the successful update (step S609). If the received data is different from the transmitted data (“NO” at step S606), the server informs the client of update failure (step S607), and ends the processing.

On the other hand, the client receives the update result (step S507), and when the update has been successful (“YES” at step S508), updates the pattern table (step S509). After finishing the update of the pattern table, or when the update has failed (“NO” at step S508), the client ends the processing.

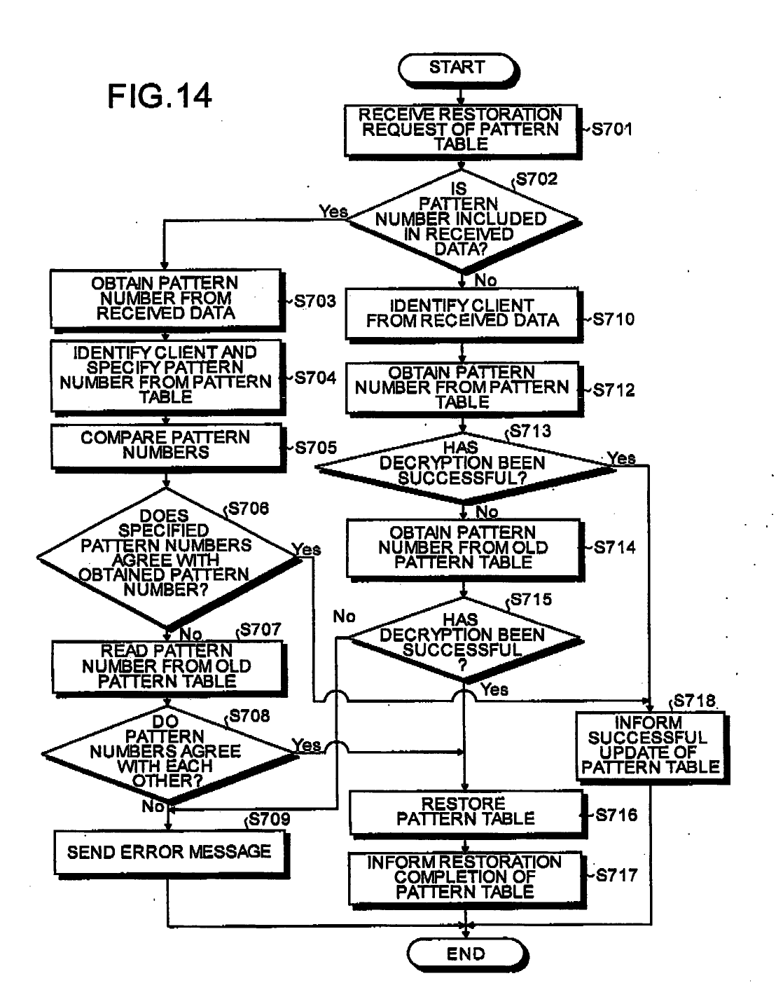

When update of the pattern table has failed, it is desired to restore the pattern table, and ensure cryptocommunication by the existing pattern table. FIG. 14 depicts one example of restoration processing of the pattern table in the server. As shown in FIG. 14, upon reception of a restoration request of the pattern table from the client (step S701), the server determines whether the pattern number is added to the received data (step S702).

When the pattern number is added to the received data (“YES” at step S702), the server obtains the pattern number from the received data (step S703). The server then specifies the client based on the IP address or the like, and specifies the pattern number based on the pattern table (step S704). Thereafter, the server compares the received pattern number with the pattern number read from the pattern table (step S705). When the pattern numbers agree with each other (“YES” at step S706), the server informs the client of the successful update of the pattern table and ends the processing.

On the other hand, when the pattern numbers do not agree with each other (“NO” at step S705), the server reads the pattern number from the old pattern table (step S707), and compares the number with the pattern number added to the data (step S708). When the pattern number added to the data agrees with the old pattern number (“YES” at step S708), the server restores the pattern table (step S716), informs the client of restoration completion of the pattern table (step S717) and ends the processing. When the pattern number added to the data does not agree with the old pattern number (“NO” at step S708), the server sends an error message to the client (step S709) and ends the processing.

When the pattern number is not added to the received data (“NO” at step S702), the server uses the IP address or the like in the received data to specify the client (step S710), and obtains a pattern number from the pattern table (step S712). The server then decrypts the received data by a secret key corresponding to the obtained pattern number. When decryption has been successful (“YES” at step S713), the server informs the client of the successful update of the pattern table and ends the processing (step S718).

On the other hand, when decryption has failed (“NO” at step S713), the server obtains a pattern number from the old pattern table (step S714) to execute decryption (step S715). When decryption using the old pattern number has been successful (“YES” at step S715), the server restores the pattern table (step S716), informs the client of restoration completion of the pattern table (step S717) and ends the processing. When decryption using the old pattern number has failed (“NO” at step S715), the server sends an error message to the client (step S709) and ends the processing.

Thus, by updating the pattern table shared between the client and the server based on the update request from the client, the pattern table to be used can be changed according to need, thereby improving the communication security.

Update of the pattern table is not limited to the second embodiment, and is also effective in the cryptocommunication system according to the first embodiment.

In the first and the second embodiments, although an example of using the RSA cryptosystem has been explained, the present invention is not limited thereto, and the present invention can be realized by using an optional encryption method.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An encryption apparatus that performs encryption on data to be transmitted, comprising:
a storage unit configured to store at least one encryption scheme;
an encrypting unit configured to encrypt the data based on the encryption scheme; and
a transmitting unit configured to transmit encrypted data.

2. The encryption apparatus according to claim 1, further comprising an adding unit configured to add pattern information to the encrypted data, the pattern information indicative of an encryption scheme that is used to encrypt the data, wherein
the storage unit stores a plurality of encryption schemes, and
the encrypting unit is configured to select a encryption scheme to be used to encrypt the data, from among the encryption schemes.

3. The encryption apparatus according to claim 1, wherein the encryption scheme includes a public key used in a public key cryptosystem, and
the encrypting unit is configured to encrypt the data based on the public key.

4. An encryption method for encrypting data to be transmitted, comprising:
storing at least one encryption scheme;
encrypting the data based on the encryption scheme; and
transmitting encrypted data.

5. The encryption method according to claim 4, further comprising adding pattern information to the encrypted data, the pattern information indicative of an encryption scheme that is used to encrypt the data, wherein
the storing includes storing a plurality of encryption schemes, and
the encrypting includes selecting a encryption scheme to be used to encrypt the data, from among the encryption schemes.

6. The encryption method according to claim 4, wherein the encryption scheme includes a public key used in a public key cryptosystem, and
the encrypting includes encrypting the data based on the public key.

7. A computer-readable recording medium that stores therein a computer program for encrypting data to be transmitted, the computer program making a computer execute:
storing at least one encryption scheme;
encrypting the data based on the encryption scheme; and
transmitting encrypted data.

8. The computer-readable recording medium according to claim 7, wherein
the computer program further makes the computer execute adding pattern information to the encrypted data, the pattern information indicative of an encryption scheme that is used to encrypt the data,
the storing includes storing a plurality of encryption schemes, and
the encrypting includes selecting a encryption scheme to be used to encrypt the data, from among the encryption schemes.

9. The computer-readable recording medium according to claim 7, wherein the encryption scheme includes a public key used in a public key cryptosystem, and
the encrypting includes encrypting the data based on the public key.
